(19) United States
(12) Patent Application Publication
(10) Pub. No.: US 2026/0163006 A1
(43) Pub. Date: Jun. 11, 2026

(54) NEGATIVE ELECTRODE AND RECHARGEABLE LITHIUM BATTERY INCLUDING THE SAME

(71) Applicant: SAMSUNG SDI CO., LTD., Yongin-si (KR)

(72) Inventors: Yookyung KIM, Yongin-si (KR); YOUNGUGK KIM, Yongin-si (KR); Deok-Hyun KIM, Yongin-si (KR); Eunji KANG, Yongin-si (KR); Jaewon KIM, Yongin-si (KR); Hyejin KIM, Yongin-si (KR); Doori OH, Yongin-si (KR); Banseok LEE, Yongin-si (KR)

(21) Appl. No.: 19/348,267

(22) Filed: Oct. 2, 2025

(30) Foreign Application Priority Data
Dec. 9, 2024 (KR) 10-2024-0181839

(51) Int. Cl. H01M 4/62; H01M 4/02; H01M 4/133; H01M 4/36; H01M 4/587

(52) U.S. Cl. CPC H01M 4/628; H01M 4/133; H01M 4/366; H01M 4/587; H01M 2004/021; H01M 2004/027

(57) ABSTRACT

A negative electrode and a rechargeable lithium battery including the negative electrode are provided. The negative electrode includes a negative electrode current collector and a negative electrode active material layer, wherein the negative electrode active material layer includes a silicon-carbon composite and a first graphite, which is artificial graphite, and wherein the silicon-carbon composite includes: a secondary particle in which primary particles are assembled; and an amorphous carbon coating layer on the primary particles and the secondary particle, wherein each of the primary particles includes a silicon nanoparticle and a metal coating layer on the silicon nanoparticle, and wherein the metal coating layer includes a first metal-based material.

### CROSS-REFERENCE TO RELATED APPLICATION

The present application claims priority to and the benefit of Korean Patent Application No. 10-2024-0181839, filed on Dec. 9, 2024, in the Korean Intellectual Property Office, the entire disclosure of which is incorporated herein by reference.

### BACKGROUND

### 1. Field

One or more embodiments of the present disclosure relate to a negative electrode and a rechargeable lithium battery including the same.

### 2. Description of the Related Art

Recently, with the rapid proliferation of battery-powered electronic devices (such as mobile phones, notebook computers) and/or electric vehicles, the demand for rechargeable batteries with high energy density and large capacity has been increasing significantly. In response, extensive research and development efforts have been made to enhance the performance of such rechargeable batteries, including rechargeable lithium batteries.

A rechargeable lithium battery generally includes a positive electrode, a negative electrode, and an electrolyte. Each of the positive electrode and the negative electrodes contains an active material that is capable of lithium-ion intercalation and deintercalation. Electrical energy is generated through oxidation and reduction reactions as lithium ions move between the electrodes during charging and discharging. For example, the electrical energy is generated when lithium ions are intercalated into the positive electrode and/or deintercalated from the negative electrode during the discharge process.

### SUMMARY

One or more aspects of embodiments of the present disclosure are directed toward a negative electrode having (with) high conductivity not only in an interior of a negative electrode active material but also on a surface of the negative electrode active material.

One or more aspects of embodiments of the present disclosure are directed toward a rechargeable lithium battery having (with) high energy density, capacity, efficiency, and a long lifetime.

Additional aspects will be set forth in part in the description which follows and, in part, will be apparent from the description, or may be learned by practice of the presented embodiments of the disclosure.

According to one or more embodiments of the present disclosure, a negative electrode may include a negative electrode current collector and a negative electrode active material layer, wherein the negative electrode active material layer may include a silicon-carbon composite and a first graphite, which is artificial graphite, and wherein the silicon-carbon composite may include: a secondary particle in which primary particles may be assembled; and an amorphous carbon coating layer on the primary particles and the secondary particle, wherein each of the primary particles may include a silicon nanoparticle and a metal coating layer on the silicon nanoparticle, and wherein the metal coating layer may include a first metal-based material.

According to one or more embodiments of the present disclosure, a rechargeable lithium battery may include the negative electrode described above.

### BRIEF DESCRIPTION OF DRAWINGS

The accompanying drawings are included to provide a further understanding of the disclosure and are incorporated in and constitute a part of this disclosure. The drawings illustrate example embodiments of the disclosure and, together with the description, serve to explain principles of the disclosure. The above and other aspects, features, and advantages of certain embodiments of the present disclosure will be more apparent from the following description taken in conjunction with the accompanying drawings.

FIG. 1 is a schematic conceptual diagram of a rechargeable lithium battery according to one or more embodiments of the present disclosure.

FIGS. 2 to 5 are each a schematic diagram illustrating a rechargeable lithium battery according to one or more embodiments of the present disclosure, FIG. 2 showing a cylindrical battery, FIG. 3 showing a prismatic battery, and FIG. 4 and FIG. 5 each showing a pouch-type (kind) battery.

FIG. 6 is a cross-sectional view of a negative electrode for a rechargeable lithium battery according to one or more embodiments of the present disclosure.

FIG. 7 is an enlarged view of a negative electrode active material layer according to one or more embodiments of the present disclosure.

FIG. 8 is a schematic diagram for describing a silicon-carbon composite according to one or more embodiments of the present disclosure.

FIG. 9 is a schematic diagram for describing a silicon-carbon composite according to one or more embodiments of the present disclosure.

FIG. 10 is an enlarged view of a negative electrode active material layer according to one or more embodiments of the present disclosure.

FIG. 11 is an enlarged view of a negative electrode active material layer according to one or more embodiments of the present disclosure.

### DETAILED DESCRIPTION

To fully understand the configuration and effects of the present disclosure, one or more example embodiments will be described with reference to the accompanying drawings. However, the present disclosure is not limited to the following example embodiments and may be implemented in one or more suitable forms. The example embodiments are provided solely to illustrate the present disclosure and to enable those skilled in the art to fully understand its scope.

In this disclosure, if (e.g., when) an element is described as being “on” another element, it may be directly on the other element, or one or more intervening elements may be present therebetween. In contrast, if (e.g., when) an element is referred to as being “directly on” another element, there are no intervening elements present therebetween. In the drawings, certain thicknesses may be exaggerated to better illustrate technical details. Throughout the disclosure, like reference numerals indicate like elements, and duplicative descriptions thereof may not be provided for conciseness.

One or more embodiments described herein may be illustrated using sectional and/or plan views, which are presented as idealized and illustrative examples of the present disclosure. The thicknesses of layers and regions in the drawings may be exaggerated for clarity. The regions shown in the drawings are for illustrative purposes and should not be construed as limiting the scope of the present disclosure. Although terms such as “first,” “second,” and “third” may be used to describe one or more suitable elements, these terms are merely used for distinction and do not imply any particular order or hierarchy. For example, a first element discussed herein could be termed a second element, without departing from the scope of the disclosure. The embodiments described and illustrated herein may include complementary variations.

The terms used in this disclosure serve only to explain one or more suitable embodiments and are not intended to limit the present disclosure. Unless explicitly stated otherwise, singular forms may also include plural forms. For example, the singular forms “a,” “an,” and “the” are intended to include the plural forms as well, unless the context clearly indicates otherwise. The terms “comprise(s)/include(s)” and/or “comprising/including” and/or “has(have)/having” do not exclude the presence or addition of one or more other components. Additionally, the terms “comprise(s)/comprising,” “include(s)/including,” “has(have)/having”, or other similar terms include or support the terms “consisting of” and “consisting essentially of,” indicating the presence of stated features, numbers, steps, operations, elements, parts, and/or components, without or essentially without the presence of other features, numbers, steps, operations, elements, parts, components, and/or groups thereof. Further, the utilization of “may” when describing embodiments of the present disclosure refers to “one or more embodiments of the present disclosure”.

In this disclosure, the phrase “combination thereof” may refer to a mixture, a stack, a composite, a copolymer, an alloy, a blend, or a reaction product of constituents.

Unless otherwise specifically defined, the term “particle diameter” or “particle size” refers to an average particle diameter/size. The particle diameter/size may represent the median particle size (D50), which corresponds to the diameter/size of particles at 50 vol % in a cumulative particle size distribution. In other words, D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size. The average particle diameter/size (D50) may be measured using widely suitable methods, such as a particle size analyzer, for example, HORIBA, LA-950 laser particle size analyzer, or by using transmission electron microscope (TEM) imaging, or scanning electron microscope (SEM) imaging. In one or more embodiments, dynamic light scattering may be used, where particle counts within size ranges are analyzed to calculate the average particle diameter/size (D50). In one or more embodiments, a laser scattering method may be employed, in which target particles are dispersed in a solvent, introduced into a laser scattering particle measurement device (e.g., MT3000 from Microtrac, Inc.), irradiated with ultrasonic waves at 28 kHz and 60 W, and subsequently analyzed to determine the D50 value based on a 50% cumulative particle size distribution. In the present disclosure, when particles are spherical, “diameter/size” indicates an average particle diameter/size, and when the particles are non-spherical, the “diameter/size” indicates an average major axis length of particles.

In the disclosure, the phrases “A or B,” “A and/or B,” “A/B,” “at least one of A and B,” “at least one of A or B,” “A, B, or C,” “at least one of A, B, and C,” and “at least one of A, B, or C” include any one or all possible combinations of the listed elements.

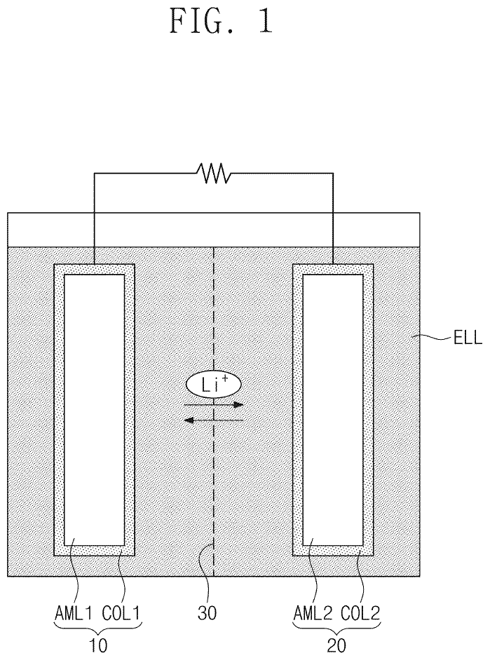

FIG. 1 is a schematic conceptual diagram of a rechargeable lithium battery according to one or more embodiments of the present disclosure. Referring to FIG. 1, a rechargeable lithium battery may include a positive electrode 10, a negative electrode 20, a separator 30, and an electrolyte solution ELL.

The positive electrode 10 and the negative electrode 20 may be spaced apart from each other by the separator 30. The separator 30 may be arranged between the positive electrode 10 and the negative electrode 20. The positive electrode 10, the negative electrode 20, and the separator 30 may be in contact with the electrolyte solution ELL. For example, the positive electrode 10, the negative electrode 20, and the separator 30 may be impregnated in the electrolyte solution ELL.

The electrolyte solution ELL may be a medium for transferring lithium ions between the positive electrode 10 and the negative electrode 20. In the electrolyte solution ELL, the lithium ions may move through the separator 30 toward the positive electrode 10 or the negative electrode 20.

### Positive Electrode 10

The positive electrode 10 for a rechargeable lithium battery may include a current collector COL1 and a positive electrode active material layer AML1 on the current collector COL1. The positive electrode active material layer AML1 may include a positive electrode active material (e.g., in a form of particles) and may further include a binder and/or a conductive material (e.g., an electrically conductive material).

In one or more embodiments, the positive electrode 10 may further include an additive that can serve as a sacrificial positive electrode.

An amount of the positive electrode active material may be about 90 wt % to about 99.5 wt % based on a total weight of 100 wt % of the positive electrode active material layer AML1. Amounts of the binder and the conductive material may each be about 0.5 wt % to about 5 wt %, based on the total weight of 100 wt % of the positive electrode active material layer AML1.

The binder serves to attach the positive electrode active material particles well to each other and also to attach the positive electrode active material well to the current collector COL1. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like, as non-limiting examples.

The conductive material (e.g., an electrically conductive material) may be used to impart conductivity (e.g., electrical conductivity) to the electrode. Any material that does not cause chemical change (e.g., does not cause an undesirable chemical change in the rechargeable lithium battery) and conducts electrons may be used in the battery. Non-limiting examples of the conductive material may include a carbon-based material such as natural graphite, artificial graphite, carbon black, acetylene black, Ketjen black, a carbon fiber, a carbon nanofiber, and carbon nanotube; a metal-based material containing copper, nickel, aluminum, silver, and/or the like, in a form of a metal powder or a metal fiber; a conductive polymer such as a polyphenylene derivative; or a mixture thereof.

In one or more embodiments, aluminum (Al) may be used as the current collector COL1, but embodiments of the present disclosure are not limited thereto.

### Positive Electrode Active Material

The positive electrode active material may include a compound (lithiated intercalation compound) that is capable of intercalating and deintercalating lithium. For example, in one or more embodiments, at least one of a composite oxide of lithium and a metal selected from among cobalt, manganese, nickel, and combinations thereof may be used.

The composite oxide may be a lithium transition metal composite oxide. Non-limiting examples of the composite oxide may include lithium nickel-based oxides, lithium cobalt-based oxides, lithium manganese-based oxides, lithium iron phosphate-based compounds, cobalt-free nickel-manganese-based oxides, and/or a combination thereof.

In one or more embodiments, one or more compounds represented by any one selected from among the following Chemical Formulas may be used: LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GeO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); and LiₐFePO₄ (0.90≤a≤1.8).

In the foregoing Chemical Formulas, A may be nickel (Ni), cobalt (Co), manganese (Mn), or a combination thereof; X may be Al, Ni, Co, Mn, chromium (Cr), iron (Fe), magnesium (Mg), strontium (Sr), vanadium (V), a rare earth element, or a combination thereof; D may be oxygen (O), fluorine (F), sulfur (S), phosphorus (P), or a combination thereof; G may be Al, Cr, Mn, Fe, Mg, lanthanum (La), cerium (Ce), Sr, V, or a combination thereof; and L¹ may be Mn, Al, or a combination thereof.

In one or more embodiments, the positive electrode active material may be, for example, a high nickel-based positive electrode active material having a nickel content (e.g., amount) of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of a total metal excluding lithium in the lithium transition metal composite oxide. The high-nickel-based positive electrode active material may be capable of realizing high capacity and may be applied to a high-capacity, high-density rechargeable lithium battery.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material (e.g., in a form of particles), and may further include a binder and/or a conductive material (e.g., an electrically conductive material).

For example, in one or more embodiments, the negative electrode active material layer AML2 may include about 90 wt % to about 99 wt % of the negative electrode active material, about 0.5 wt % to about 5 wt % of the binder, and about 0 wt % to about 5 wt % of the conductive material, based on a total weight of 100 wt % of the negative electrode active material layer.

The binder may serve to attach the negative electrode active material particles well to each other and also to attach the negative electrode active material well to the current collector COL2. The binder may include a non-aqueous (e.g., water-insoluble) binder, an aqueous (water-soluble) binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from among a styrene-butadiene rubber, a (meth)acrylated styrene-butadiene rubber, a (meth)acrylonitrile-butadiene rubber, a (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the binder of the negative electrode, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material (e.g., electrically conductive material) may be used to impart conductivity (e.g., electrical conductivity) to the electrode. Any material that does not cause chemical change (e.g., does not cause an undesirable chemical change in the rechargeable lithium battery) and that conducts electrons may be used in the battery. Non-limiting examples thereof may include a carbon-based material such as natural graphite, artificial graphite, carbon black, acetylene black, Ketjen black, a carbon fiber, a carbon nanofiber, and a carbon nanotube; a metal-based material including copper, nickel, aluminum, silver, and/or the like in a form of a metal powder or a metal fiber; a conductive polymer such as a polyphenylene derivative; and/or a mixture thereof.

The negative current collector COL2 may include a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include a material that reversibly intercalates/deintercalates lithium ions, a lithium metal, a lithium metal alloy, a material capable of doping/dedoping lithium, and/or a transition metal oxide.

The material that reversibly intercalates/deintercalates lithium ions may include a carbon-based negative electrode active material, such as, for example, crystalline carbon, amorphous carbon, or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and/or the like.

The lithium metal alloy includes an alloy of lithium and a metal selected from among sodium (Na), potassium (K), rubidium (Rb), cesium (Cs), francium (Fr), beryllium (Be), magnesium (Mg), calcium (Ca), strontium (Sr), silicon (Si), antimony (Sb), lead (Pb), indium (In), zinc (Zn), barium (Ba), radium (Ra), germanium (Ge), aluminum (Al), and tin (Sn).

The material capable of doping/dedoping lithium may be a Si-based negative electrode active material or a Sn-based negative electrode active material. The Si-based negative electrode active material may include silicon, a silicon-carbon composite, SiOₓ (0<x≤2), a Si-Q alloy (where Q is selected from among an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnOₖ (0<k≤2) (e.g., SnO₂), a Sn-based alloy, or a combination thereof.

The silicon-carbon composite (e.g., in a form of particles) may be a composite of silicon and amorphous carbon. According to one or more embodiments, the silicon-carbon composite may be in a form of silicon particles and amorphous carbon coated on a surface of the silicon particle. For example, in one or more embodiments, the silicon-carbon composite may include a secondary particle (core) in which primary silicon particles are assembled, and an amorphous carbon coating layer (shell) on a surface of the secondary particle. The amorphous carbon may also be between the primary silicon particles, and, for example, the primary silicon particles may be coated with the amorphous carbon. The secondary particle may exist dispersed in an amorphous carbon matrix.

In one or more embodiments, the silicon-carbon composite may further include crystalline carbon. For example, the silicon-carbon composite may include a core including crystalline carbon and silicon particles and an amorphous carbon coating layer on a surface of the core.

In one or more embodiments, the Si-based negative electrode active material and/or the Sn-based negative electrode active material may be used in combination with a carbon-based negative electrode active material.

### Separator 30

Depending on the type (kind) of the rechargeable lithium battery, the separator 30 may be present between the positive electrode 10 and the negative electrode 20. The separator 30 may include polyethylene, polypropylene, polyvinylidene fluoride, or a multilayer film of two or more layers thereof, for example, a mixed multilayer film such as a polyethylene/polypropylene two-layer separator, a polyethylene/polypropylene/polyethylene three-layer separator, a polypropylene/polyethylene/polypropylene three-layer separator, and/or the like.

The separator 30 may include a porous substrate and a coating layer including an organic material, an inorganic material, or a combination thereof on one or both surfaces (e.g., two opposite surfaces) of the porous substrate.

The porous substrate may be a polymer film formed of any one selected from among polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, and polytetrafluoroethylene (e.g., TEFLON), or a copolymer or a mixture of two or more thereof.

The organic material may include a polyvinylidene fluoride-based polymer or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but embodiments of the present disclosure are not limited thereto.

In one or more embodiments, the organic material and the inorganic material may be mixed in one coating layer, or a coating layer including an organic material and a coating layer including an inorganic material may be stacked.

### Electrolyte ELL

The electrolyte solution ELL for a rechargeable lithium battery may include a non-aqueous organic solvent and a lithium salt.

The non-aqueous organic solvent may serve as a medium for transmitting ions taking part in an electrochemical reaction of the rechargeable lithium battery.

The non-aqueous organic solvent may be a carbonate-based solvent, an ester-based solvent, an ether-based solvent, a ketone-based solvent, an alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. In addition, the ketone-based solvent may include cyclohexanone, and/or the like. The alcohol-based solvent may include ethanol, isopropyl alcohol, and/or the like, and the aprotic solvent may include nitriles such as R—CN (wherein R is a C2 to C20 linear, branched, or cyclic hydrocarbon group, and may include a double bond, an aromatic ring, or an ether bond, and/or the like); amides such as dimethylformamide; dioxolanes such as 1,3-dioxolane, 1,4-dioxolane, and/or the like; sulfolanes; and/or the like.

The non-aqueous organic solvents may be used alone or in combination of two or more thereof.

In addition, if (e.g., when) using a carbonate-based solvent, a cyclic carbonate and a chain carbonate may be mixed and used, and the cyclic carbonate and the chain carbonate may be mixed in a volume ratio of about 1:1 to about 1:9.

The lithium salt dissolved in the non-aqueous organic solvent supplies lithium ions in a rechargeable lithium battery, enables a basic operation of the rechargeable lithium battery, and improves transportation of the lithium ions between the positive electrode and the negative electrode. Non-limiting examples of the lithium salt include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluoro(oxalato)borate (LiDFOB), lithium difluorobis(oxalato)phosphate (LiDFBOP), and lithium bis(oxalato)borate (LiBOB).

### Rechargeable Lithium Battery

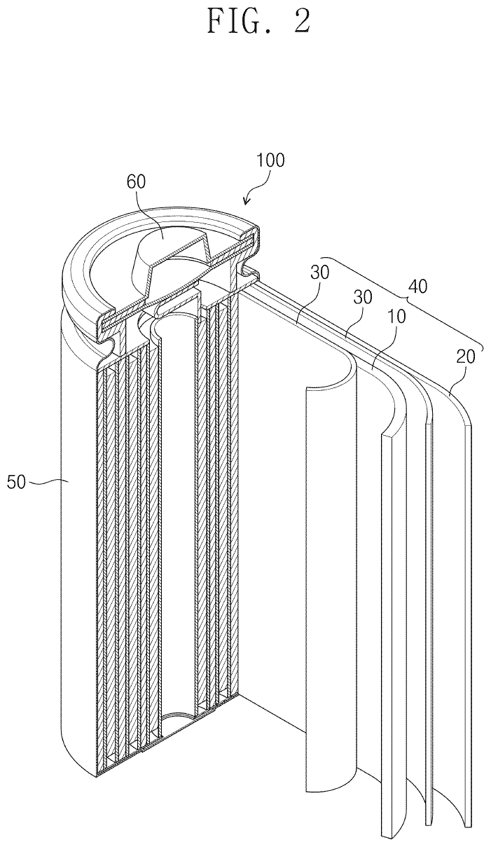

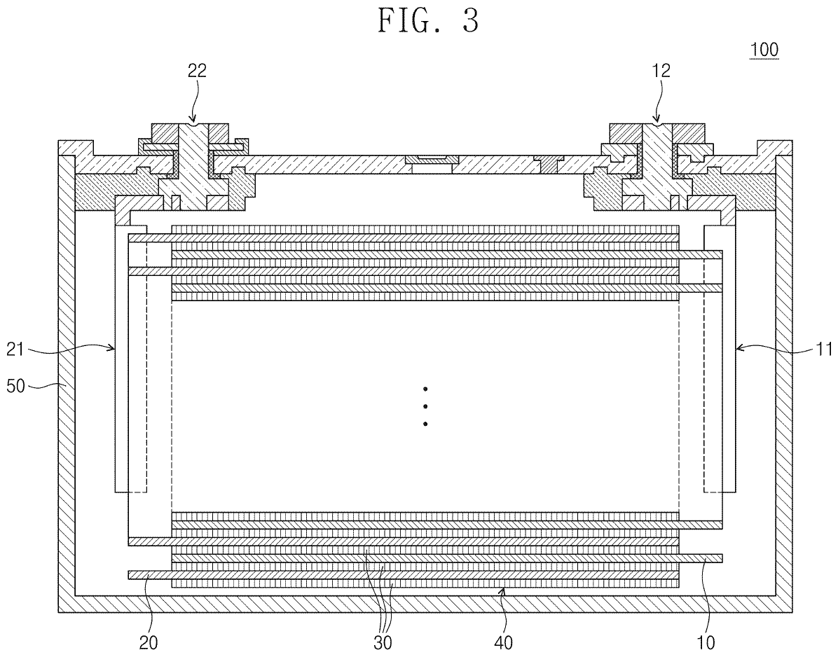

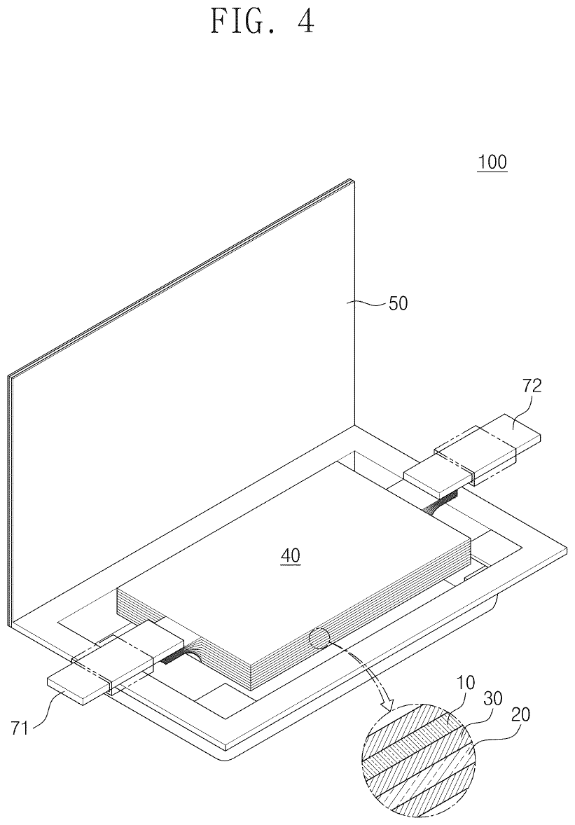

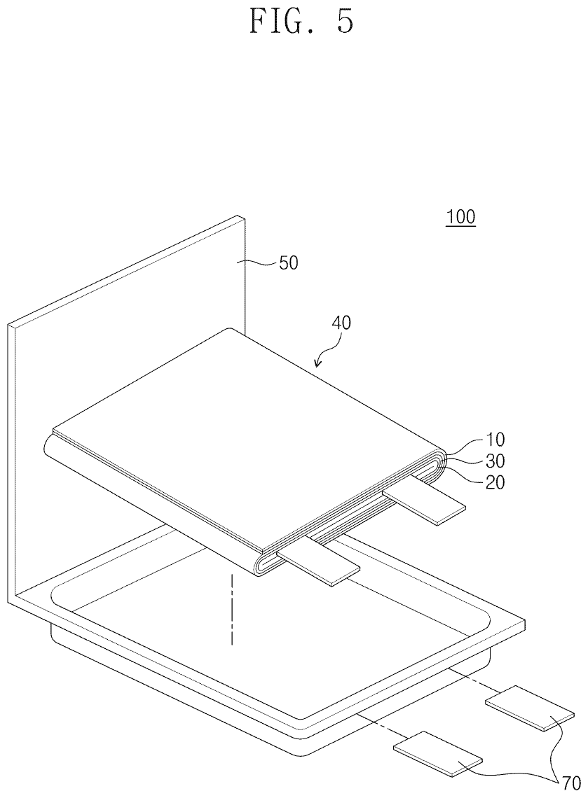

The rechargeable lithium battery may be classified into a cylindrical, prismatic, pouch, or coin-type (kind) battery, and/or the like depending on its shape. FIGS. 2 to 5 are schematic views each illustrating a rechargeable lithium battery according to one or more embodiments of the present disclosure. FIG. 2 shows a cylindrical battery, FIG. 3 shows a prismatic battery, and FIGS. 4 and 5 show pouch-type (kind) batteries. Referring to FIGS. 2 to 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution. In one or more embodiments, the rechargeable lithium battery 100 may include a sealing member 60 sealing the case 50, as shown in FIG. 2. In one or more embodiments, as shown in FIG. 3, the rechargeable lithium battery 100 may include a positive lead tab 11, a positive terminal 12, a negative lead tab 21, and a negative terminal 22. In one or more embodiments, as shown in FIGS. 4 and 5, the rechargeable lithium battery 100 may include an electrode tab 70, which may be, for example, a positive electrode tab 71 and a negative electrode tab 72, serving as an electrical path for inducing the current formed in the electrode assembly 40 to the outside.

The rechargeable lithium battery according to one or more embodiments may be applied to automobiles, mobile phones, and/or one or more suitable types (kinds) of electric devices, as non-limiting examples.

Hereinafter, the negative electrode 20 according to one or more embodiments of the present disclosure will be described in more detail.

### Negative Electrode 20

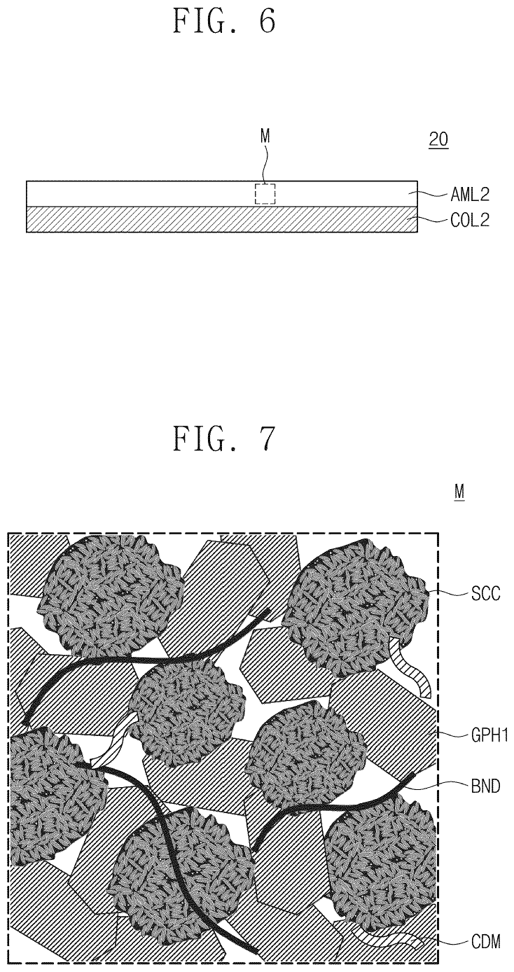

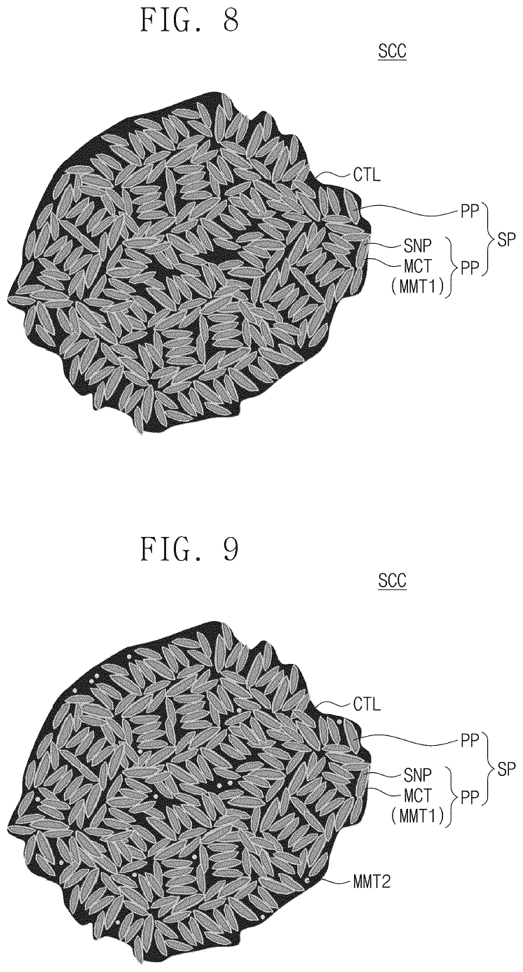

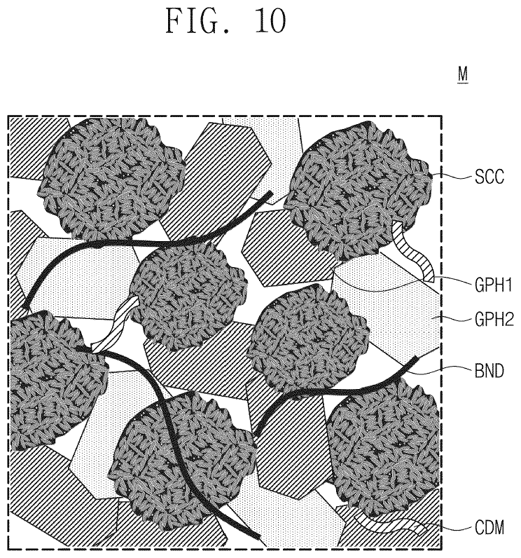

FIG. 6 is a cross-sectional view of a negative electrode 20 according to one or more embodiments of the present disclosure. FIG. 7 is an enlarged view of the region M in FIG. 6 according to one or more embodiments. FIG. 8 is a cross-sectional view for illustrating a silicon-carbon composite SCC according to one or more embodiments of the present disclosure. FIG. 9 is a cross-sectional view for illustrating a silicon-carbon composite SCC according to one or more embodiments of the present disclosure. Hereinafter, for convenience of description, description of the same matters as those described with reference to FIGS. 1 to 5 will not be provided, and only differences will be described in more detail.

Referring to FIG. 6, a negative electrode 20 according to one or more embodiments of the present disclosure may include a negative electrode current collector COL2 and a negative electrode active material layer AML2 positioned on the negative electrode current collector COL2. The negative electrode current collector COL2 is the same as described above.

Referring to FIG. 7, the negative electrode active material layer AML2 may include a silicon-carbon composite SCC (e.g., in a form of particles) and a first graphite GPH1 (e.g., in a form of particles) as negative electrode active materials, and may further include a binder BND and/or a conductive material CDM. Examples of the binder BND are as described above.

The negative electrode active material layer AML2 may include about 0.1 wt % to about 5 wt % of the binder BND based on a total weight of 100 wt % of the negative electrode active material layer AML2. For example, in one or more embodiments, the negative electrode active material layer AML2 may include about 0.5 wt % to about 3 wt %, or about 1 wt % to about 2 wt % of the binder BND, based on the total weight of 100 wt % of the negative electrode active material layer AML2. The type (kind) of the binder BND is as described above. For example, in one or more embodiments, the binder BND may include a styrene-butadiene rubber and carboxymethyl cellulose.

The negative electrode active material layer AML2 may include about 0 wt % to about 5 wt % of the conductive material CDM based on a total weight of 100 wt % of the negative electrode active material layer AML2. The type (kind) of the conductive material CDM is as described above. For example, in one or more embodiments, the conductive material CDM may include a carbon-based material. The carbon-based material may include carbon black, acetylene black, Ketjen black, a carbon fiber, a carbon nanofiber, a carbon nanotube, and/or the like. The carbon nanotube may include a single-walled carbon nanotube (SWCNTs), a multi-walled carbon nanoparticle (MWCNTs), and/or the like.

For example, in one or more embodiments, the carbon-based material constituting the conductive material CDM may have a one-dimensional nanostructure. The one-dimensional nanostructure may be defined as, for example, a structure in which the size of any one of the three dimensions is larger than the sizes of the other two dimensions. For example, in one or more embodiments, the one-dimensional nanostructure may be defined as a nanostructure in which a length of the nanostructure is much larger than a diameter or a width and a thickness of the nanostructure.

The carbon-based material having the one-dimensional nanostructure may have a length of about 0.5 micrometers (μm) to about 100 μm. For example, the carbon-based material may have a length of about 1 μm to about 100 μm, about 1 μm to about 50 μm, about 1 μm to about 20 μm, or about 5 μm to about 20 μm.

An aspect ratio of the carbon-based material having the one-dimensional nanostructure may be about 10 to about 3000. For example, in one or more embodiments, the aspect ratio of the carbon-based material may be about 10 to about 2600, about 20 to about 2500, or about 30 to about 2400. The aspect ratio may be calculated as a ratio of the length of the carbon-based material to the diameter of the carbon-base material.

For example, the size, structure, and length of the carbon-based material constituting the conductive material CDM may be confirmed through scanning electron microscopy (SEM), transmission electron microscopy (TEM), atomic force microscopy (AFM), and/or the like.

For example, the carbon-based material constituting the conductive material CDM may be identified through Raman spectroscopy. For example, in the embodiments of a carbon-based material having a one-dimensional nanostructure, a radical breathing mode (RBM) peak appearing in a range of about 70 cm⁻¹ to about 300 cm⁻¹ may appear in a Raman spectrum for the conductive material CDM. For example, in the embodiment of a carbon-based material having a one-dimensional nanostructure, a G⁻ band and a G⁺ band may appear in a Raman spectrum for the conductive material CDM.

For example, the carbon-based material constituting the conductive material CDM may be identified through X-ray photoelectron spectroscopy (XPS). For example, in a XPS spectrum for a conductive material CDM, a complex C 1s peak may be observed.

The conductive material CDM having the above structure may form either line contact or surface contact with the constituents of the negative electrode active material layer AML2. A silicon-carbon composite SCC having a sphericity of about 0.85 or more may have a small interparticle contact area. When the conductive material CDM having the above-described structure is contained, a conductive path between particles of the silicon-carbon composite SCC and a conductive path between the silicon-carbon composite SCC and/or the first graphite GPH1 may be secured.

The negative electrode active material layer AML2 may include about 90 wt % to about 99 wt % of the negative electrode active material (that is, the silicon-carbon composite SCC and the first graphite GPH1) based on the total weight of 100 wt % of the negative electrode active material layer AML2. For example, the negative electrode active material layer AML2 may include the silicon-carbon composite SCC and the first graphite GPH1 in an amount of about 95 wt % to about 99 wt %, or about 97 wt % to about 98 wt % with respect to the total weight of the negative electrode active material layer AML2. When the total amount of the silicon-carbon composite SCC and the first graphite GPH1 satisfy the ranges described above, a rechargeable lithium battery having excellent or suitable energy density, capacity, and efficiency and having a long lifetime may be provided.

The negative electrode active material layer AML2 may contain more of the first graphite GPH1 than the silicon-carbon composite SCC. For example, in one or more embodiments, a weight ratio of the silicon-carbon composite SCC to the first graphite GPH1 may be about 2:98 to about 40:60, about 2:98 to about 20:80, about 5:95 to about 15:85, or about 7:93 to about 13:87.

An amount of the silicon-carbon composite SCC in the negative electrode active material layer AML2 may be about 2 wt % to about 40 wt % relative to the total weight of the negative electrode active material layer AML2. For example, in one or more embodiments, the amount of the silicon-carbon composite SCC in the negative electrode active material layer AML2 may be about 2 wt % to about 20 wt %, about 5 wt % to about 15 wt %, or about 7 wt % to about 13 wt % relative to the total weight of the negative electrode active material layer AML2.

An amount of the first graphite GPH1 in the negative electrode active material layer AML2 may be the content (e.g., amount) remaining after excluding the amounts of the silicon-carbon composite SCC, the binder BND, and the conductive material CDM in the total weight of the negative electrode active material layer AML2.

When the weight ratio of the silicon-carbon composite SCC to the first graphite GPH1, the amount of the silicon-carbon composite SCC, and the amount of the first graphite GPH1 satisfy the ranges described above, a rechargeable lithium battery having excellent or suitable energy density, capacity, and efficiency and having a long lifetime may be provided.

Referring to FIG. 8, the silicon-carbon composite SCC may include a secondary particle SP in which primary particles PP are assembled, and an amorphous carbon coating layer CTL. Each of the primary particles PP may include a silicon nanoparticle SNP and a metal coating layer MCT around (e.g., surrounding) the silicon nanoparticle SNP. The metal coating layer MCT may include a first metal-based material MMT1.

The secondary particle SP may be an assembly of the primary particles PP. The secondary particle SP may be an agglomerate of a plurality of primary particles PP. For example, one secondary particle SP may include the plurality of primary particles PP agglomerated with one another. The secondary particle SP may have a spherical shape or an elliptical shape.

An average particle diameter of the secondary particle SP may be about 3 μm to about 20 μm. For example, in the present disclosure, the average particle diameter may be measured by a particle size analyzer. The average particle diameter may refer to the diameter of particles corresponding to 50 vol % in a cumulative particle size distribution. When the average particle diameter of the secondary particle SP satisfies the range described above, it may exhibit excellent or suitable high-rate characteristics and cycle characteristics.

A shape of the primary particle PP may not be limited. For example, the shape of the primary particle PP may be plate-like or spherical. For example, in one or more embodiments, the shape of the primary particles PP may be flake type (kind).

An average particle diameter of the silicon nanoparticle SNP may be about 10 nanometers (nm) to about 1000 nm. For example, in one or more embodiments, the average particle diameter of the silicon nanoparticle SNP may be about 10 nm to about 200 nm, or about 20 nm to about 150 nm. When the average particle diameter of the silicon nanoparticle SNP satisfies the above-described range, the volume expansion of the silicon nanoparticle SNP during charging and discharging may be controlled or selected, and the structure collapse may be prevented or reduced.

For example, in one or more embodiments, the silicon nanoparticle SNP may have a major axis and a minor axis. For example, the major axis may be a length (or a width) of the silicon nanoparticle SNP, and the minor axis may be a thickness of the silicon nano particle SNP. For example, an aspect ratio (major axis/minor axis) of the silicon nanoparticle SNP may be from about 5 to about 20. When the aspect ratio of the silicon nanoparticle SNP satisfies the above-described range, the volume expansion of the silicon nanoparticle SNP during charge and discharge may be controlled or selected, and the structure collapse may be prevented or reduced.

An amount of silicon nanoparticle SNP may be about 30 wt % to about 80 wt % relative to (e.g., based on) the total weight of the silicon-carbon composite SCC. For example, in one or more embodiments, the amount of the silicon nanoparticle SNP may be about 44 wt % to about 75 wt %, about 50 wt % to about 70 wt %, or about 50 wt % to about 62 wt % relative to the total weight of the silicon-carbon composite SCC. When the amount of the silicon nanoparticle SNP satisfies the range described above, a rechargeable lithium battery with excellent or suitable capacity and efficiency may be provided.

As will be described in more detail below, the metal coating layer MCT may be formed by mixing a silicon precursor and a metal-based material precursor using ball milling equipment. The metal coating layer MCT may be arranged on the silicon nanoparticle SNP. The metal coating layer MCT may surround the silicon nanoparticle SNP. In one or more embodiments, the metal coating layer MCT may include a first metal-based material MMT1 in layered (layer type (kind)) form which is continuously located on the surface of the silicon nanoparticle SNP. In one or more embodiments, the metal coating layer MCT may include a first metal-based material MMT1 present in an island form on the surface of the silicon nanoparticle SNP. Because the surface of the silicon nanoparticle SNP is mostly covered by the metal coating layer MCT, the surface of the silicon nanoparticle SNP may be substantially shielded from exposure. Thereby, the internal conductivity of the silicon-carbon composite SCC may be improved, which may improve the charge-discharge uniformity. In addition, the improvement in electrical conductivity due to the metal coating layer MCT may increase the utilization of silicon and reduce side reactions.

For example, the first metal-based material MMT1 may be a metal or a metal compound. The metal compound may be a metal oxide, a metal nitride, or a combination thereof.

The metal may be a metal that is capable of alloying with lithium. For example, the metal may be an alkali metal, an alkaline earth metal, a Group 13 element, a Group 14 element, a Group 15 element, a Group 16 element, a transition metal, a rare earth element, or a combination thereof. For example, the metal may be silver (Ag), magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), gold (Au), zinc (Zn), cadmium (Cd), boron (B), aluminum (Al), gallium (Ga), tin (Sn), indium (In), thallium (TI), germanium (Ge), phosphorous (P), arsenic (As), antimony (Sb), bismuth (Bi), sulfur (S), selenium (Se), tellurium (Te), polonium (Po), or a combination thereof. For example, in one or more embodiments, the metal may be at least one of Ag, Cu, Al, or Au.

A thickness of the metal coating layer MCT may be about 0.1 nm to about 30 nm. For example, in one or more embodiments, the thickness of the metal coating layer MCT may be about 1 nm to about 30 nm, about 1 nm to about 20 nm, or about 5 nm to about 20 nm. When the thickness of the metal coating layer MCT satisfies the above-described range, the internal conductivity of the silicon-carbon composite SCC may be improved, allowing for substantially uniform utilization of the interior of the silicon-carbon composite SCC during battery operation.

The amorphous carbon coating layer CTL may be arranged on the primary particles PP and the secondary particle SP. For example, the amorphous carbon coating layer CTL may surround the primary particles PP and the secondary particle SP. For example, the amorphous carbon coating layer CTL may be filled between the primary particles PP and may also be arranged on the surface of the secondary particle SP.

The amorphous carbon coating layer CTL may include amorphous carbon. The amorphous carbon may be non-graphitizable carbons (hard carbons), graphitizable carbons (soft carbons), mesophase pitch carbides, calcined coke, or a combination thereof. The amorphous carbon may have excellent or suitable hardness and electrical conductivity.

A thickness of the amorphous carbon coating layer CTL may be about 1 nm to about 2 μm. For example, in one or more embodiments, the thickness of the amorphous carbon coating layer CTL may be about 1 nm to about 500 nm, about 1 nm to about 300 nm, or about 20 nm to about 200 nm.

An amount of amorphous carbon may be the weight remaining after excluding the total weight of the silicon nanoparticle SNP and the first metal-based material MMT1 from the total weight of the silicon-carbon composite SCC. For example, in one or more embodiments, the amount of amorphous carbon may be about 20 wt % to about 50 wt %, about 25 wt % to about 46 wt %, or about 30 wt % to about 40 wt % relative to the total weight of the silicon-carbon composite SCC.

When the thickness of the amorphous carbon coating layer CTL and the amount of amorphous carbon satisfy the above-described ranges, the amorphous-carbon coating layer CLT may have excellent or suitable hardness, the structure of the silicon-carbon composite SCC may be maintained, and the lifetime of the rechargeable lithium battery may be improved.

For example, the amorphous carbon coating layer CTL may have a D band (peak position: around 1350±50 cm⁻¹) and a G band (peak position: around 1580±50 cm⁻¹) in a Raman spectrum obtained by Raman spectroscopy. Herein, the D/G ratio may refer to a ratio of the maximum peak intensity of the D band to the maximum peak intensity in the G band. For example, in one or more embodiments, the D/G ratio of the amorphous carbon coating layer CTL may be at least about 1.0. For example, in one or more embodiments, the D/G ratio of the amorphous carbon coating layer CTL may be about 1.0 to about 1.5.

Referring to FIG. 9, the amorphous carbon coating layer CTL may further include a second metal-based material MMT2. The second metal-based material MMT2 may be dispersed in the amorphous carbon coating layer CTL. The second metal-based material MMT2 included in the amorphous carbon coating layer CTL may be a result of some of the first metal-based material MMT1 being incorporated into the amorphous carbon coating layer CTL during the process of forming the metal coating layer MCT on the surface of the silicon nanoparticle SNP in the manufacturing of the silicon-carbon composite SCC. For example, the second metal-based material MMT2 may be the same as the first metal-based material MMT1 described above.

For example, the second metal-based material MMT2 may be a metal or a metal compound. The metal compound may be a metal oxide, a metal nitride, or a combination thereof.

The metal may be a metal that is capable of alloying with lithium. For example, the metal may be an alkali metal, an alkaline earth metal, a Group 13 element, a Group 14 element, a Group 15 element, a Group 16 element, a transition metal, a rare earth element, or a combination thereof. For example, the metal may be Ag, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Au, Zn, Cd, B, Al, Ga, Sn, In, TI, Ge, P, As, Sb, Bi, S, Se, Te, Po, or a combination thereof. For example, in one or more embodiments, the metal may be at least one of Ag, Cu, Al, or Au.

The amorphous carbon coating layer CTL including the second metal-based material MMT2 may be distributed both (e.g., simultaneously) on the surface of the primary particles PP and the surface of the secondary particle SP, meaning that it is present both (e.g., simultaneously) on the inside and outside of the silicon-carbon composite SCC, so that the conductivity of the silicon-carbon composite SCC may be improved on both (e.g., simultaneously) the inside and outside. For example, the amorphous carbon coating layer CTL including the second metal-based material MMT2 is present inside the silicon-carbon composite SCC and on the surface of the silicon-carbon composite SCC, so that the conductivity of the silicon-carbon composite SCC may be improved on both (e.g., simultaneously) the inside and the surface.

A particle diameter of the second metal-based material MMT2 may be 1 nm to 30 nm. For example, in one or more embodiments, the particle diameter of the second metal-based material MMT2 may be about 1 nm to about 20 nm, or about 5 nm to about 20 nm. When the particle diameter of the second metal-based material MMT2 satisfies the above-described range, the interior of the silicon-carbon composite SCC may be uniformly (e.g., substantially uniformly) utilized during battery operation.

In the silicon-carbon composite SCC, a total amount of the first metal-based material MMT1 and the second metal-based material MMT2 may be about 0.01 wt % to about 20 wt % relative to (e.g., based on) the total weight of 100 wt % of the silicon-carbon composite SCC. For example, in one or more embodiments, the total amount of the first metal-based material MMT1 and the second metal-based material MMT2 may be about 0.05 wt % to about 15 wt %, or about 0.01 wt % to about 10 wt % relative to the total weight of 100 wt % of the silicon-carbon composite SCC. When the total amount of the first metal-based material MMT1 and the second metal-based material MMT2 satisfies the range described above, the internal conductivity of the silicon-carbon composite SCC may be improved, allowing for substantially uniform utilization of the interior of the silicon-carbon composite SCC during battery operation.

The silicon-carbon composite SCC may have a relatively low Brunauer-Emmett-Teller (BET) specific surface area. For example, in one or more embodiments, the BET specific surface area of the silicon-carbon composite SCC may be in a range of about 0.5 m²/g to about 2 m²/g. For example, in one or more embodiments, the BET specific surface area of the silicon-carbon composite SCC may be in the range of about 0.8 m²/g to about 2 m²/g, or about 0.8 m²/g to about 1.5 m²/g. When the BET specific surface area of the silicon-carbon composite SCC satisfies the range described above, side reactions to (with) the electrolytic solution may be reduced, and the lifetime of the rechargeable lithium battery may be extended.

The silicon-carbon composite SCC may have a span value according to Equation 1 of about 1.1 to about 1.6.

$$Span value = ( D 90 - D 10 ) / D 50 \qquad Equation 1$$

In Equation, D10 may refer to the particle diameter corresponding to 10 vol % in a cumulative particle size distribution, D50 may refer to the particle diameter corresponding to 50 vol % in the cumulative particle size distribution, and D90 may refer to the particle diameter corresponding to 90 vol % in the cumulative particle size distribution.

For example, in one or more embodiments, the span value of the silicon-carbon composite SCC may be about 1.1 to about 1.55, or about 1.1 to about 1.5. When the span value of the silicon-carbon composite SCC satisfies the range described above, the silicon-carbon composite SCC may substantially exclude fine particles. The silicon-carbon composite SCC may have a low specific surface area, reduce side reactions to the electrolytic solution, and extend the lifetime of the rechargeable lithium battery.

For example, the silicon-carbon composite SCC may include a peak corresponding to the Si(111) plane and a peak corresponding to a metal(111) plane when measured by XRD using CuKα radiation. A maximum intensity of the peak corresponding to the Si(111) plane may appear at a diffraction angle (2θ) in the range of about 27.5° to about 29.5°. A maximum intensity of the peak corresponding to the metal(111) plane may appear at a diffraction angle (2θ) in the range of about 37.5° to about 40.0°. For example, the metal may be Ag.

An intensity ratio (Iₘₑₜₐₗ₍₁₁₁₎/I_{Si(111)}) of the intensity of the peak corresponding to the metal(111) plane (Iₘₑₜₐₗ₍₁₁₁₎) to the intensity of the peak corresponding to the Si(111) plane (I_{Si(111)}), may be about 0.05 to about 0.5. For example, the intensity ratio (Iₘₑₜₐₗ₍₁₁₁₎/I_{Si(111)}) may be about 0.2 to about 0.4, or about 0.1 to about 0.4. For example, the metal may be silver (Ag). When the intensity ratio (Iₘₑₜₐₗ₍₁₁₁₎/I_{Si(111)}) satisfies the above-described range, silicon and metal (e.g., Ag) may exist in the desired or suitable amount within the silicon-carbon composite SCC, thereby improving the internal conductivity of the silicon-carbon composite SCC and allowing for the substantially uniform utilization of the interior of the silicon-carbon composite SCC during battery operation.

For example, the intensity of the peak may be a height value of the peak or an integrated area value of the peak.

For example, the XRD measurement may be performed under conditions of a diffraction angle (2θ) of about 20° to about 80°, a scan rate of about 0.044°/s to about 0.089°/s, and a step size of about 0.013°/step to about 0.039°/step.

The silicon-carbon composite SCC may have a spherical or nearly spherical shape. The sphericity (S) of the silicon-carbon composite SCC may be expressed by Equation 2.

$$Sphericity ( S ) = {P}^{2} / \{ 4 π \times A ) \qquad Equation 2$$

In Equation 2, A may be the cross-sectional area of the silicon-carbon composite SCC, and P (perimeter) may be the perimeter of the cross-section of the silicon-carbon composite SCC.

A and P may be derived by obtaining a scanning electron microscope (SEM) image of a cross section of the negative electrode 20 or a SEM image of the silicon-carbon composite SCC, and analyzing a cross section of any silicon-carbon composites SCC identified from the image using a program such as Image J. For example, the sphericity may be a value obtained when a three-dimensional particle is projected on a two-dimensional plane.

A and P may be not only the cross-sectional area and perimeter if (e.g., when) the shape of the cross-section of the silicon-carbon composite SCC is completely spherical, but also the cross-sectional area and perimeter obtained along the uneven regions if these regions are present in the cross-section of silicon-carbon composites SCC.

The sphericity according to Equation 2 may have a value from 0 to 1. The closer the sphericity according to Equation 2 is to 1, the closer the cross-section of the silicon-carbon composite SCC may be to a circle. The silicon-carbon composite SCC may be non-spherical (or irregular) as the sphericity according to Equation 2 is closer to zero.

According to one or more embodiments, the silicon-carbon composite SCC may have a sphericity (S) according to Equation 2 of about 0.85 to about 1.0. For example, in one or more embodiments, the silicon-carbon composite SCC may have a sphericity (S) according to Equation 2 of about 0.88 to about 0.95, about 0.89 to about 0.92, about 0.93 to about 0.98, or about 0.93 to about 0.95. When the sphericity S according to the Equation 2 satisfies the range described above, the silicon-carbon composite SCC may be spherical or nearly spherical in shape.

Because the negative electrode active material layer AML2 includes the spherical silicon-carbon composite SCC, the silicon-carbon composites SCC may efficiently utilize space within the negative electrode active material layer AML2. The silicon-carbon composite SCC may have an excellent or suitable tap density, and may increase the packing density in the production of the negative electrode 20. In addition, because the negative electrode active material layer AML2 includes the spherical silicon-carbon composite SCC, the silicon-carbon composites SCC may be uniformly (e.g., substantially uniformly) dispersed in the negative electrode active material layer AML2, which may help reduce the expansion rate. When the silicon-carbon composite SCC is mixed with the first graphite GPH1, the spherical silicon-carbon composites SCC may be better inserted into a matrix of the first graphite GPH1, allowing for more uniformly (e.g., substantially uniformly) dispersed throughout the negative electrode active material layer AML2 and further reducing the expansion rate. Thus, a rechargeable lithium battery having excellent or suitable energy density, capacity, efficiency, and long lifetime may be provided.

The silicon-carbon composite SCC may be manufactured by the following method.

A method for manufacturing a silicon-carbon composite SCC according to one or more embodiments of the present disclosure may include: spray-drying a dispersion including a silicon precursor, a metal-based material precursor, and a solvent to produce a secondary particle (S1); and heat-treating the secondary particle and a carbon precursor to form an amorphous carbon coating layer (S3).

In step (e.g., act or task) S1, the dispersion may be prepared by adding a silicon precursor, a metal-based material precursor, and a dispersant to a solvent. For example, a mixing process may be performed by ball milling using zirconia balls and/or the like. However, the mixing process is not limited to the described examples as long as it can grind the silicon precursor. During the mixing process, the micro-sized silicon precursor may be ground into nano-sized silicon primary particles (see SNP in FIG. 8).

For example, in one or more embodiments, the silicon precursor may have an average particle diameter of about 1 μm to about 10 μm. For example, the average particle diameter of the nano-sized silicon primary particles may be about 1 nm to about 1000 nm, about 10 nm to about 1000 nm, or about 20 nm to about 150 nm.

The metal-based material precursor may be a metal, a metal nitride, a metal carbide, a metal sulfide, a metal halide, or a combination thereof. For example, the metal halide may be a metal fluoride or a metal chloride. The metal may be a metal that is capable of alloying with lithium. Examples of the metal are as described above.

The silicon precursor and the metal-based material precursor may be mixed in a weight ratio of about 100:1 to about 100:30. For example, in one or more embodiments, the mixing ratio of the silicon precursor and the metal-based material precursor may be about 100:1 to about 100:25.

The dispersant may be stearic acid, boron nitride (BN), magnesium sulfide (MgS), polyvinylpyrrolidone (PVP), or a combination thereof. The dispersant may sufficiently disperse the silicon precursor and the metal-based material precursor in the dispersion.

The solvent may include an alcohol. For example, the solvent may include at least one selected from the group consisting of isopropyl alcohol, ethanol, and butanol.

Through spray-drying, a metal coating layer (see MCT in FIG. 8) including a metal-based material may be formed on the surface of the silicon primary particles (see SNP in FIG. 8), and the silicon primary particles and the metal coating layer may be densely assembled to form a secondary particle (see SP in FIG. 8). The secondary particle may have a substantially uniform particle diameter, a spherical shape, and a porous structure.

In step (e.g., act or task) S3, the secondary particle and the carbon precursor may be heat-treated to form a coating layer. The coating layer may be the amorphous carbon coating layer CTL of FIG. 8.

For example, the carbon precursor may be mixed with the secondary particle. For example, in one or more embodiments, the carbon precursor may include at least one selected from the group consisting of petroleum-based coke, coal-based coke, petroleum-based pitch, coal-based pitch, and green coke. For example, the heat treatment may be performed in an N₂ or He atmosphere.

In one or more embodiments, the carbon precursor may be a gas, and the step (e.g., act or task) S3 may be carried out by chemical vapor deposition (CVD). For example, the carbon precursor may be provided in gaseous form on the secondary particle. For example, the carbon precursor may include methane (CH₄) gas, ethylene (C₂H₄) gas, acetylene (C₂H₂) gas, propane (C₃H₈) gas, propylene (C₃H₆) gas, or a combination thereof.

In this step (e.g., act or task), a portion of the metal-based material may be included in the amorphous carbon coating layer.

The heat treatment may be performed at about 600° C. to about 1,000° C. The dispersant may be removed during the heat treatment. When the heat treatment temperature satisfies the above-described range, it may prevent or reduce the silicon nanoparticles from excessively growing, prevent or reduce the formation of SiC, and improve the electrical conductivity of the amorphous carbon.

Thereafter, the method for manufacturing a silicon-carbon composite SCC according to one or more embodiments of the present disclosure may further include a classification step (e.g., act or task) (S5). The classification step (e.g., act or task) S5 may be performed using a sieve so that the span value of the silicon-carbon composite SCC satisfies the range described above.

In one or more embodiments, the method for manufacturing the silicon-carbon composite SCC according to the present disclosure may include: spray-drying a dispersion including a silicon precursor to produce a secondary particle; forming a metal coating layer on the secondary particle using chemical vapor deposition (CVD); and heat-treating the carbon precursor to form an amorphous carbon coating layer on the secondary particle with the metal coating layer.

Referring back to FIG. 7, the negative electrode active material layer AML2 may also include the first graphite GPH1 (e.g., in a form of particle). The first graphite GPH1 may be crystalline carbon. Crystalline carbon may be more ductile than amorphous carbon.

The first graphite GPH1 may be artificial graphite. The artificial graphite may have excellent or suitable electrical conductivity. Artificial graphite may have a highly oriented and substantially uniform structure. Artificial graphite may have more migration pathways of lithium ions than natural graphite. Artificial graphite may have high charge-discharge efficiency, excellent or suitable rapid charging characteristics, and a long lifetime.

For example, in one or more embodiments, the first graphite GPH1 may further include amorphous carbon around (e.g., surrounding) the artificial graphite. For example, the amorphous carbon may be soft carbons.

The first graphite GPH1 may not be spherical. For example, in one or more embodiments, the first graphite GPH1 may be irregular or non-uniform. The sphericity according to Equation 2 of the first graphite GPH1 may be smaller than the sphericity of the silicon-carbon composite SCC according to Equation 2. For example, in one or more embodiments, the sphericity according to Equation 2 of the first graphite GPH1 may be about 0.5 to about 0.95, about 0.6 to about 0.9, or about 0.65 to about 0.85, or about 0.65 or more and less than about 0.85.

An aspect ratio of the first graphite GPH1 may be about 1 to about 3. The aspect ratio of the first graphite GPH1 may be defined as a ratio of the major axis length to the minor axis length of the first graphite GPH1.

For example, the first graphite GPH1 may be identified through X-ray diffraction (XRD) analysis, graphitization degree analysis, Raman analysis, and/or the like.

For example, a degree of graphitization of the first graphite GPH1 may be less than about 90%. In the present disclosure, the “degree of graphitization” may refer to the ratio of the layered structure contained in the graphite. A high degree of graphitization may refer to that the graphite contains a large amount of a layered structure. The graphitization degree may be obtained by X-ray diffraction measurement. For example, using an X-ray diffraction analyzer (for example, Bruker D8 Discover), d002 value may be measured in accordance with JIS K 0131-1996 or JB/T 4220-2011 standards, and then the degree of graphitization may be determined by calculation with (0.344−d002)/(0.344−0.3354)×100%. Here, d002 is the interlayer spacing of the graphite crystal structure expressed in nanometers (nm). The X-ray diffraction measurement may be performed using a CuKα radiation as the target radiation, for example under conditions of a wavelength of λ±0.02 Å, a diffraction angle (2θ) of about 20° to about 80°, and a scan rate of about 1°/min to about 5°/min.

The negative electrode 20 and the rechargeable lithium battery, which include the negative electrode active material layer AML2 according to one or more embodiments of the present disclosure, may have the following characteristics by including the above-described configurations.

The negative electrode active material layer AML2 according to one or more embodiments of the present disclosure includes the silicon-carbon composite SCC that may be uniformly (e.g., substantially uniformly) utilized from the outer region to the inner region thereof during charging and discharging, and the first graphite GPH1 that may improve the electrical conductivity on the exterior of the silicon-carbon complex SCC, so that the electrical conductivity of the negative electrode 20 may be improved and the resistance may be reduced. Thus, the rechargeable lithium battery according to one or more embodiments of the present disclosure may have excellent or suitable energy density, capacity, and efficiency, and may also have a long lifetime due to the reduced load on the electrode plate.

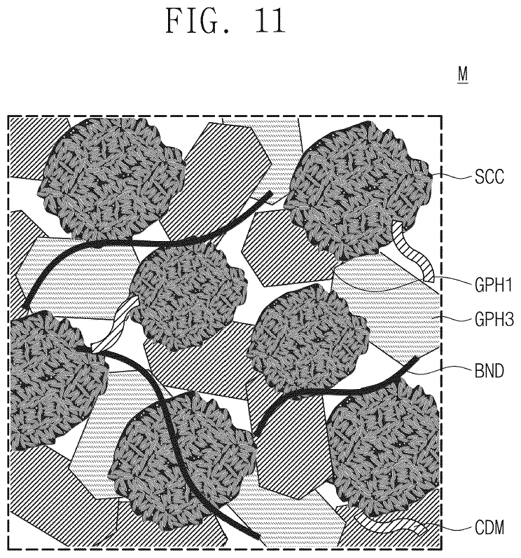

FIG. 10 and FIG. 11 are each a diagram for explaining other embodiments of the present disclosure. In the embodiments to be described later, the technical features overlapping those described above with reference to FIGS. 1 to 8 will not be described in more detail, and differences will be described in more detail.

Referring to FIG. 10, the negative electrode 20 according to one or more embodiments of the present disclosure may further include a second graphite GPH2 in addition to the silicon-carbon composite SCC, the first graphite GPH1, the binder BND, and the conductive material CDM. The second graphite GPH2 may be crystalline carbon. Crystalline carbon may be more ductile than amorphous carbon.

The second graphite GPH2 may be natural graphite. Natural graphite may have excellent or suitable electrical conductivity. Natural graphite may have a large charge-discharge capacity. Natural graphite may have low mechanical strength and may be easily pressed during pressing of the negative electrode active material layer AML2. Accordingly, the density of the negative electrode active material layer AML2 may be increased.

For example, in one or more embodiments, the second graphite GPH2 may further include amorphous carbon around (e.g., surrounding) the natural graphite. For example, the amorphous carbon may be soft carbons.

The second graphite GPH2 may not be spherical. For example, the second graphite GPH2 may be irregular or non-uniform. The sphericity according to Equation 2 of the second graphite GPH2 may be smaller than the sphericity of the silicon-carbon composite SCC according to Equation 2. For example, in one or more embodiments, the sphericity according to Equation 2 of the second graphite GPH2 may be about 0.5 to about 0.95, about 0.6 to about 0.9, about 0.65 to about 0.85, or about 0.65 or more and less than about 0.85.

An aspect ratio of the second graphite GPH2 may be about 1 to about 3.

For example, the second graphite GPH2 may be identified through X-ray diffraction (XRD) analysis, graphitization degree analysis, Raman analysis, and/or the like.

For example, as a result of X-ray diffraction (XRD) analysis of the second graphite GPH2, a broad diffraction peak may be observed. For example, the peaks corresponding to the (002) plane may be widely dispersed.

For example, the values of the crystallite size along the a-axis (La) and the c-axis (Lc) from X-ray diffraction analysis of the second graphite GPH2 may be small.

For example, a degree of graphitization of the second graphite GPH2 may be at least about 90%. For example, in one or more embodiments, the degree of graphitization of the second graphite GPH2 may be about 98% to about 100%.

When further including the second graphite GPH2, the negative electrode active material layer AML2 may include about 90 wt % to about 99 wt % of the silicon-carbon composite SCC, the first graphite GPH1, and the second graphite as the negative electrode active materials with respect to the total weight of the negative electrode active material layer AML2. For example, in one or more embodiments, the negative electrode active material layer AML2 may include the silicon-carbon composite SCC, the first graphite GPH1, and the second graphite GPH2 in an amount of about 95 wt % to about 99 wt %, or about 97 wt % to about 98 wt % with respect to the total weight of the negative electrode active material layer AML2.

A weight ratio of silicon-carbon composite SCC to the graphite (first graphite GPH1 and second graphite GPH2) may be about 2:98 to about 40:60. For example, in one or more embodiments, the weight ratio of silicon-carbon composite SCC to the graphite (first graphite GPH1 and second graphite GPH2) may be from about 2:98 to about 20:80, about 5:95 to about 15:85, or about 7:93 to about 13:87.

A weight ratio of the first graphite GPH1 to the second graphite GPH2 may be about 8:2 to about 5:5.

When the amounts of the silicon-carbon composite SCC, the first graphite GPH1, and the second graphite GPH2 satisfy the above-described ranges, the energy density and the charge-discharge capacity of the rechargeable lithium battery may be further increased.

Referring to FIG. 11, the negative electrode 20 according to one or more embodiments of the present disclosure may further include a third graphite GPH3 in addition to the silicon-carbon composite SCC, the first graphite GPH1, the binder BND, and the conductive material CDM. The third graphite GPH3 may be crystalline carbon. Crystalline carbon may be more ductile than amorphous carbon.

The third graphite GPH3 may be artificial graphite. The artificial graphite may have excellent or suitable electrical conductivity. Artificial graphite may have a highly oriented and substantially uniform structure. Artificial graphite may have more migration pathways of lithium ions than natural graphite. Artificial graphite may have high charge-discharge efficiency, excellent or suitable rapid charging characteristics, and a long lifetime.

For example, in one or more embodiments, the third graphite GPH3 may further include amorphous carbon around (e.g., surrounding) the artificial graphite. For example, the amorphous carbon may be soft carbons.

The third graphite GPH3 may not be spherical. For example, the third graphite GPH3 may be irregular or non-uniform. The sphericity according to Equation 2 of the third graphite GPH3 may be smaller than the sphericity of the silicon-carbon composite SCC according to Equation 2. For example, in one or more embodiments, the sphericity of the third graphite GPH3 according to the Equation 2 may be about 0.1 or more and less than about 0.5.

An aspect ratio of the third graphite GPH3 may be greater than about 3 and less than or equal to about 20.

When further including the third graphite GPH3, the negative electrode active material layer AML2 may include about 90 wt % to about 99 wt % of the silicon-carbon composite SCC, the first graphite GPH1, and the third graphite GPH3 based on the total weight of 100 wt % of the negative electrode active material layer AML2. For example, in one or more embodiments, the negative electrode active material layer AML2 may include the silicon-carbon composite SCC, the first graphite GPH1, and the third graphite GPH3 in an amount of about 95 wt % to about 99 wt %, or about 97 wt % to about 98 wt % with respect to (e.g., based on) the total weight of 100 wt % of the negative electrode active material layer AML2.

A weight ratio of the silicon-carbon composite SCC to the graphite (first graphite GPH1 and third graphite GPH3) may be about 2:98 to about 40:60. For example, in one or more embodiments, the weight ratio of the silicon-carbon composite SCC to the graphite (first graphite GPH1 and third graphite GPH3) may be about 2:98 to about 20:80, about 5:95 to about 15:85, or about 7:93 to about 13:87.

A weight ratio of the first graphite GPH1 to the third graphite GPH3 may be about 8:2 to about 5:5.

When the amounts of the silicon-carbon composite SCC, the first graphite GPH1, and the third graphite GPH3 satisfy the ranges described above, the energy density, capacity, and charge-discharge efficiency of the rechargeable lithium battery may be further increased, and the lifetime may be further extended.

Hereinafter, the present disclosure will be described in more detail with reference to Examples. However, these examples are intended to illustrate the present disclosure, and the scope of the present invention is not limited to these examples.

### Preparation Example: Manufacturing of Silicon-Carbon Composite SCC

A silicon precursor having an average particle diameter of 8 μm, nano-sized Ag (average particle diameter of 100 nm), and a stearic acid dispersant were added to ethanol, and the dispersion was prepared by grinding and mixing the mixture for 8 hours using ball milling with zirconia balls. The weight ratio of the silicon precursor to the dispersant was 100:25, and the weight ratio of silicon precursor to nano-sized Ag was 100:20. Thus, silicon primary particles having an average particle diameter of 100 nm were formed, and a metal coating layer (Ag coating layer) was formed on the surface of the silicon primary particles.

A secondary particle with an average particle diameter of 7 μm was prepared by spray-drying the dispersion, wherein a plurality of silicon primary particles was agglomerated and formed a porous structure.

The secondary particle and the petroleum pitch were mixed at a weight ratio of 60:40, and heat-treated at a temperature of 1000° C. under an N₂ atmosphere to form an amorphous carbon coating layer (e.g., in/on the secondary particle).

Thereafter, a classification step (e.g., act or task) was performed so that the span value satisfied the range described above, thereby manufacturing a silicon-carbon composite SCC.

The manufactured silicon-carbon composite SCC included a secondary particle in which the primary particles were assembled, and an amorphous carbon coating layer on the primary particles and the secondary particle. Each of the primary particles included a silicon nanoparticle having an average particle diameter of 100 nm and a metal coating layer (Ag coating layer, thickness=20 nm) on the silicon nanoparticle. The average particle diameter of the secondary particle was 7 μm. The amorphous carbon coating layer contained Ag having a particle size of 15 nm.

Here, the total amount of Ag was 10 wt %, the amount of silicon nanoparticles was 50 wt %, and the amount of amorphous carbon was 40 wt %, relative to the total weight of the silicon-carbon composite SCC. The sphericity of the silicon-carbon composite SCC was 0.94.

### Example 1

A slurry was prepared by mixing 97.5 wt % of a negative electrode active material (the silicon-carbon composite SCC according to Preparation Example: the first graphite GPH1=13:87 by weight ratio), 1 wt % of a conductive material (carbon nanotube), and 1.5 wt % of a binder (carboxymethyl cellulose and styrene-butadiene rubber) with distilled water. For the first graphite GPH1, artificial graphite having a sphericity of 0.8 and an aspect ratio of 2 was used. The slurry was applied to a Cu foil, dried, and pressed to prepare a negative electrode. The negative electrode active material layer of the prepared negative electrode included the silicon-carbon composite SCC and the first graphite GPH1 in a weight ratio of 13:87.

Again, to manufacture the silicon-carbon composite (SCC), a silicon precursor with an average particle diameter of 8 μm, nano-sized Ag (average particle diameter of 100 nm), and a stearic acid dispersant were added to ethanol. The mixture was ground and mixed for 8 hours using ball milling with zirconia balls, resulting in silicon primary particles with an average particle diameter of 100 nm and a metal coating layer (Ag coating layer) on their surface. The dispersion was then spray-dried to form secondary particles with an average particle diameter of 7 μm, creating a porous structure. These secondary particles were mixed with petroleum pitch at a weight ratio of 60:40 and heat-treated at 1000° C. under an N₂ atmosphere to form an amorphous carbon coating layer. The final silicon-carbon composite SCC included secondary particles with assembled primary particles, each having a silicon nanoparticle with an Ag coating layer, and an amorphous carbon coating layer containing Ag particles.

In Example 1, a slurry was prepared by mixing 97.5 wt % of the negative electrode active material (silicon-carbon composite SCC and graphite GPH1 at a weight ratio of 13:87), 1 wt % of a conductive material (carbon nanotube), and 1.5 wt % of a binder (carboxymethyl cellulose and styrene-butadiene rubber) with distilled water. The slurry was applied to a Cu foil, dried, and pressed to prepare a negative electrode.

Subsequent examples, as provided in more detail below, varied the weight ratios of silicon-carbon composite SCC and graphite GPH1 or included different types of graphite (GPH2 and GPH3) to prepare negative electrodes with different compositions, demonstrating the versatility of the silicon-carbon composite SCC in enhancing the performance of rechargeable lithium batteries.

### Example 2

A negative electrode was prepared in substantially the same manner as in Example 1 except that silicon-carbon composite SCC and the first graphite GPH1 were mixed at a weight ratio of 8:92 as negative electrode active materials in the preparation of the slurry. The negative electrode active material layer of the prepared negative electrode included the silicon-carbon composite SCC and the first graphite GPH1 in a weight ratio of 8:92.

### Example 3

A negative electrode was prepared in substantially the same manner as in Example 1 except that silicon-carbon composite SCC and the first graphite GPH1 were mixed at a weight ratio of 3:97 as negative electrode active materials in the preparation of the slurry. The negative electrode active material layer of the prepared negative electrode included the silicon-carbon composite SCC and the first graphite GPH1 in a weight ratio of 3:97.

### Example 4

A negative electrode was prepared in substantially the same manner as in Example 1 except that silicon-carbon composite SCC and the first graphite GPH1 were mixed at a weight ratio of 20:80 as negative electrode active materials in the preparation of the slurry. The negative electrode active material layer of the prepared negative electrode included the silicon-carbon composite SCC and the first graphite GPH1 in a weight ratio of 20:80.

### Example 5

A negative electrode was prepared in substantially the same manner as in Example 1 except that the silicon-carbon composite SCC and graphite (the first graphite GPH1:the second graphite GPH2=5:5 by weight ratio) were mixed at a weight ratio of 13:87 as negative electrode active materials in the preparation of the slurry, and natural graphite having a sphericity of 0.8 and an aspect ratio of 2 was used as the second graphite GPH2. The negative electrode active material layer of the prepared negative electrode included the silicon-carbon composite SCC and graphite (the first graphite GPH1 and the second graphite GPH2) in a weight ratio of 13:87, and the weight ratio of the first graphite GPH1 to the second graphite GPH2 was 5:5.

### Example 6

A negative electrode was prepared in substantially the same manner as in Example 1 except that the silicon-carbon composite SCC and graphite (the first graphite GPH1:the third graphite GPH3=5:5 by weight ratio) were mixed at a weight ratio of 13:87 as negative electrode active materials in the preparation of the slurry, and artificial graphite having a sphericity of 0.3 and an aspect ratio of 8 was used as the third graphite GPH3. The negative electrode active material layer of the prepared negative electrode included the silicon-carbon composite SCC and graphite (the first graphite GPH1 and the third graphite GPH3) in a weight ratio of 13:87, and the weight ratio of the first graphite GPH1 to the third graphite GPH3 was 5:5.

### Comparative Example 1

A negative electrode was prepared in substantially the same manner as in Example 1 except that only the silicon-carbon composite SCC of the Preparation Example was added as the negative electrode active material in the preparation of the slurry. The negative electrode active material layer of the prepared negative electrode included the silicon-carbon composite SCC and the first graphite GPH1 in a weight ratio of 100:0.

### Comparative Example 2

A negative electrode was prepared in substantially the same manner as in Example 1 except that the silicon-carbon composite manufactured without adding any nano-sized Ag was mixed instead of the silicon-carbon composite (SCC) in the Preparation Example.

### Preparation of Rechargeable Lithium Battery

A half-cell was respectively fabricated using the aforementioned negative electrode, lithium metal counter electrode, and an electrolyte. The electrolyte used was an organic solvent mixture of ethylene carbonate (EC) and dimethyl carbonate (DMC) in a 3:7 volume ratio, with 1 M LiPF₆ dissolved in it.

In addition, a coin-type (kind) full-cell was respectively fabricated using the aforementioned negative electrode, a LiCoO₂ positive electrode, and an electrolyte by a general method in the art. The electrolyte used was an organic solvent mixture of ethylene carbonate (EC) and dimethyl carbonate (DMC) in a 3:7 volume ratio, with 1 M LiPF₆ dissolved in it.

### Evaluation Example 1: Performance Evaluation of Negative Electrode

The resistivities of the negative electrodes according to Examples 1 to 6 and Comparative Examples 1 and 2 were each evaluated.

The resistances of the negative electrodes according to Examples and Comparative Examples were each measured using a powder resistance measurement system (MCP-PD51, Mitsubishi Chemical Group). Each of the slurries used in Examples and Comparative Examples was dried and then ground into powder. A certain amount of each powder was filled into a holder, and then pressure was applied to prepare a respective pellet. The mass of each pellet was 1.5 g, and the radius of each pellet was 10 mm. The resistance value (R) of each pellet was measured using a Four-point probe method at each applied pressure. The resistivity at a compression density of 1.6 g/cc was calculated using a correction factor in consideration of the thickness and the shape of the pellet, along with the resistance value obtained. The electrical conductivity has an inverse relationship with the resistivity.

$$Resistivity Calculation Formula \text{:} ρ = G \times R , G = 3.575 \times t$$

(ρ: resistivity, R: resistance value, G: shape correction factor, t: pellet thickness)

The results are shown in Table 1.

TABLE 1

| Items | Resistivity (Ω · cm) |
|---|---|
| Example 1 | 0.18 |
| Example 2 | 0.13 |
| Example 3 | 0.10 |
| Example 4 | 0.25 |
| Example 5 | 0.20 |
| Example 6 | 0.20 |
| Comparative Example 1 | 0.35 |
| Comparative Example 2 | 0.26 |

Referring to Table 1, the negative electrodes according to Examples 1 to 6 each included the silicon-carbon composite SCC and graphite together, so that their resistivities were each smaller than the resistivity of the negative electrode according to Comparative Example 1. Looking at the results of the negative electrodes according to Examples 1 to 4, it was confirmed that when the negative electrode contains the silicon-carbon composite SCC and graphite together, the resistivity decreased as the amount of the graphite increased.

In addition, the negative electrodes according to Examples 1, 5, and 6 each included a silicon-carbon composite SCC including a metal coating layer and a second metal-based material, and thus each had a smaller resistivity than the negative electrode according to Comparative Example 2.

Thus, it was confirmed that each of the negative electrodes according to Examples 1 to 6 had excellent or suitable electrical conductivity.

### Evaluation Example 2: Performance Evaluation of Rechargeable Lithium Battery

The capacity, efficiency, and lifetime of the rechargeable lithium batteries including corresponding negative electrodes according to Examples 1 to 6 and Comparative Examples 1 and 2 were evaluated.

A half-cell including a negative electrode according to each of Examples and Comparative Examples was charged and discharged once at 0.1 C to evaluate the charge-discharge capacity. The charge-discharge efficiency (i.e., efficiency) was obtained by calculating the ratio of the measured discharge capacity to the measured charge capacity.

The coin-type (kind) full-cells fabricated in Examples and Comparative Examples each were charged and discharged once at 0.1 C and once at 0.2 C in the range of 2.5 V to 4.2 V, and then repeatedly charged and discharged at 1 C for n cycles. The charging/discharging method and cut-off conditions were as follows.
Charging: constant current-constant voltage, 4.2 V/0.01 C cut-off
Discharge: constant voltage, 2.5 V cut-off

The number of cycles (n) at which the ratio (capacity retention rate) of the discharge capacity at n^{th} cycle to the discharge capacity at the first cycle reached 85% was obtained to represent the lifetime of the battery.

The results are shown in Table 2.

TABLE 2

| | Discharge | | Lifetime |
|---|---|---|---|
| | capacity | Efficiency | (Number of |
| Items | (mAh/g) | (%) | Cycles) |
| Example 1 | 540 | 91 | 600 |
| Example 2 | 465 | 92 | 750 |
| Example 3 | 390 | 93 | 1100 |
| Example 4 | 640 | 88 | 400 |
| Example 5 | 540 | 91 | 600 |
| Example 6 | 540 | 91 | 600 |
| Comparative | 1850 | 85 | 15 |
| Example 1 | | | |
| Comparative | 500 | 90 | 480 |
| Example 2 | | | |

Referring to Table 2, the rechargeable lithium batteries including Examples 1 to 6 each included the silicon-carbon composite SCC and graphite together, and thus each had superior charge-discharge efficiency and longer lifetime than the rechargeable lithium battery including Comparative Example 1, while having a discharge capacity of 380 mAh/g or more. Looking at the results of the rechargeable lithium batteries including Examples 1 to 4, it was confirmed that although the discharge capacity decreased as the amount of the graphite increased when the silicon-carbon composite SCC and the graphite were included together, the charge-discharge efficiency and the lifetime characteristics improved. In particular, it was confirmed that the rechargeable lithium batteries including Examples 1 and 2 each exhibited a discharge capacity of 450 mAh/g or more, a charge-discharge efficiency of 90% or more, and the number of cycles in which the capacity retention rate reached 85% of 500 cycles or more, demonstrating that they showed excellent or suitable results in all of the discharge capacity, charge-discharge efficiency, and lifetime characteristics.

In addition, it was confirmed that the rechargeable lithium batteries of Examples 1, 5, and 6, each of which contains the silicon-carbon composite (SCC) with a metal coating layer and a second metal-based material, were excellent or suitable in all of the discharge capacity, charge-discharge efficiency, and lifetime characteristics compared with the rechargeable lithium battery of Comparative Example 2.

The negative electrode according to one or more embodiments of the present disclosure may have low resistance and excellent or suitable conductivity, so that the load on the electrode plate may be reduced. This reduction in load may lead to improved efficiency and performance of the battery, as lower resistance facilitates smoother electron flow during charging and discharging cycles. The incorporation of the silicon-carbon composite (SCC) with a metal coating layer and graphite enhances the electrical conductivity of the negative electrode, thereby minimizing or reducing energy loss and enhancing the overall functionality of the battery. This characteristic is beneficial in applications requiring high power output and rapid charge-discharge cycles, such as in electric vehicles and/or portable electronic devices.

The rechargeable lithium battery according to one or more embodiments of the present disclosure may have an excellent or suitable energy density and may be excellent or suitable in all of the discharge capacity, efficiency, and lifetime characteristics. The silicon-carbon composite SCC, with its unique structure and composition, contributes to higher energy storage capacity and prolonged battery life. The evaluation results demonstrated that batteries incorporating the SCC and graphite combinations had superior charge-discharge efficiency and longer lifetimes compared to conventional batteries. For instance, batteries from Examples 1 and 2 showed discharge capacities of over 450 mAh/g, charge-discharge efficiencies of over 90%, and lifetimes exceeding 500 cycles. These attributes make the disclosed rechargeable lithium batteries suitable for demanding applications, ensuring reliable performance and extended operational periods, which are desired for consumer electronics, renewable energy storage systems, and/or electric vehicles.

In the present disclosure, expressions such as “at least one of,” “one of,” and “selected from,” when preceding a list of elements, modify the entire list of elements and do not modify the individual elements of the list. For example, “at least one of a, b or c”, “at least one selected from a, b, and c”, “at least one selected from among a to c”, etc., may indicate only a, only b, only c, both (e.g., simultaneously) a and b, both (e.g., simultaneously) a and c, both (e.g., simultaneously) b and c, all of a, b, and c, or variations thereof. The “/” utilized herein may be interpreted as “and” or as “or” depending on the situation.

In the context of the present disclosure and unless otherwise defined, the terms “use,” “using,” and “used” may be considered synonymous with the terms “utilize,” “utilizing,” and “utilized,” respectively.

In present disclosure, the term “Group” as utilized herein refers to a group of the Periodic Table of Elements according to the 1 to 18 grouping system of the International Union of Pure and Applied Chemistry (“IUPAC”).

As used herein, the terms “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is also inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, or 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

A battery manufacturing device, a battery management system (BMS) device, and/or any other relevant devices or components according to embodiments of the present invention described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

While the present disclosure has been described with reference to example embodiments, it should be understood that these embodiments are provided for illustrative purposes only and do not limit the scope of the present disclosure. Various modifications and equivalent arrangements may be made without departing from the spirit and scope of the appended claims and equivalents thereof. Accordingly, the described embodiments should be regarded as examples rather than limitations of the present disclosure.

What is claimed is:

1. A negative electrode comprising:
a negative electrode current collector; and
a negative electrode active material layer,
wherein the negative electrode active material layer comprises:
a silicon-carbon composite; and
a first graphite,
the first graphite being artificial graphite, and
wherein the silicon-carbon composite comprises:
a secondary particle comprising a plurality of primary particles; and
an amorphous carbon coating layer on the primary particles and the secondary particle,
wherein each of the primary particles comprises:
a silicon nanoparticle; and
a metal coating layer on the silicon nanoparticle, and
wherein the metal coating layer comprises a first metal-based material.

2. The negative electrode as claimed in claim 1, wherein the first metal-based material is a metal or a metal compound,
the metal compound being a metal oxide, a metal nitride, or a combination thereof, and
the metal being an alkali metal, an alkaline earth metal, a Group 13 element, a Group 14 element, a Group 15 element, a Group 16 element, a transition metal, a rare earth element, or a combination thereof.

3. The negative electrode as claimed in claim 2, wherein the metal is Ag, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Au, Zn, Cd, B, Al, Ga, Sn, In, TI, Ge, P, As, Sb, Bi, S, Se, Te, Po, or a combination thereof.

4. The negative electrode as claimed in claim 2, wherein
in an XRD spectrum obtained utilizing CuKα radiation, a maximum intensity of a peak corresponding to a (111) plane of the metal appears at a diffraction angle (2θ) in a range of about 37.5° to about 40.0°.

5. The negative electrode as claimed in claim 2, wherein
in an XRD spectrum obtained utilizing CuKα radiation, an intensity ratio (I_{metal (111)}/I_{Si(111)}) of a peak corresponding to a (111) plane of the metal to that corresponding to a Si(111) plane is about 0.05 to about 0.5.

6. The negative electrode as claimed in claim 1, wherein the amorphous carbon coating layer comprises a second metal-based material.

7. The negative electrode as claimed in claim 6, wherein the second metal-based material has a particle diameter of about 1 nm to about 30 nm.

8. The negative electrode as claimed in claim 6, wherein a total amount of the first metal-based material and the second metal-based material is about 0.01 wt % to about 20 wt % based on a total weight of 100 wt % of the silicon-carbon composite.

9. The negative electrode as claimed in claim 1, wherein the amorphous carbon coating layer has a D/G ratio of about 1.0 to about 1.5.

10. The negative electrode as claimed in claim 1, wherein a sphericity of the silicon-carbon composite is about 0.85 to about 1.0.

11. The negative electrode as claimed in claim 1, wherein the silicon-carbon composite has a BET specific surface area of about 0.5 m²/g to about 2 m²/g.

12. The negative electrode as claimed in claim 1, wherein a sphericity of the first graphite is about 0.5 to about 0.95.

13. The negative electrode as claimed in claim 1, wherein an aspect ratio of the first graphite is about 1 to about 3.

14. The negative electrode as claimed in claim 1, wherein an amount of the silicon-carbon composite and the first graphite is about 90 wt % to about 99 wt % based on a total weight of 100 wt % of the negative electrode active material layer.

15. The negative electrode as claimed in claim 1, wherein a weight ratio of the silicon-carbon composite to the first graphite is about 2:98 to about 40:60.

16. The negative electrode as claimed in claim 1, wherein the negative electrode active material layer further comprises at least one of a second graphite which is natural graphite, or a third graphite having an aspect ratio different from an aspect ratio of the first graphite.

17. The negative electrode as claimed in claim 16, wherein a weight ratio of the first graphite to either the second graphite or the third graphite is in a range of about 8:2 to about 5:5.

18. The negative electrode as claimed in claim 16, wherein an amount of a negative electrode active material in the negative electrode active material layer is about 90 wt % to about 99 wt % based on a total weight of 100 wt % of the negative electrode active material layer, and
wherein the negative electrode active material comprises:
the silicon-carbon composite;
the first graphite; and
at least one of the second graphite or the third graphite.

19. The negative electrode as claimed in claim 1, wherein the negative electrode active material layer further comprises:
a conductive material; and
a binder,
wherein the conductive material comprises a carbon-based material, and
wherein the binder is a non-aqueous binder, an aqueous binder, a dry binder, or a combination thereof.

20. A rechargeable lithium battery comprising the negative electrode as claimed in claim 1.
